(19) United States
(12) Patent Application Publication
(10) Pub. No.: US 2006/0253617 A1
(43) Pub. Date: Nov. 9, 2006

(54) Driver upgrade tools

(75) Inventors: Eugene S. Lin, Seattle, WA (US); Jason T. Cobb, Sammamish, WA (US); James G. Cavalaris, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/112,294

(22) Filed: Apr. 22, 2005

(51) Int. Cl. G06F 3/00

(52) U.S. Cl. 710/8

(57) ABSTRACT

A system to manage software component replacement is presented. The system comprises a component that identifies a unique identifier associated with a software component. The system also includes an upgrade component that applies an upgrade policy as a function of a comparison of the unique identifier with an identifier associated with software to replace. Methods for using the presented system are also provided.

### TECHNICAL FIELD

The disclosed invention relates generally to the field of software component replacement and specifically to systems and methods for managing replacement of software components.

### BACKGROUND

Modern computing systems typically include with a number of peripheral components such as printers, video displays, audio and video components, and networking devices, among others. In order to operate with these peripherals, the computing system usually employs a device driver that provides a predefined set of functions. These functions generally include means by which the computing system can communicate with the peripheral device in addition to a variety of user-selectable functions or features of the peripheral device.

Many types of peripheral devices employ standardized operational protocols or include common hardware components. Even so, vendors usually have both the ability and desire to customize their peripheral devices. Accordingly, device drivers are usually provided by a manufacturer or distributor of a specific peripheral device. Users, however, have the ability to replace an original driver with a replacement version. The replacement version may be released by a vendor to correct defects in a pervious version, to provide additional functionality, or to interoperate better with various other system components, among other reasons. Replacement drivers can also be provided by third parties.

Replacing device drivers can sometimes have unintended consequences. For example, a replacement device driver may not provide all the functionality of an original driver. A replacement device driver may work well for the peripheral device for which it was designed but may interfere with the functioning of drivers of other devices or other components. These consequences, among others, can make troubleshooting computing problems exceptionally difficult. Current software upgrade or replacement systems do not adequately address these consequences.

### SUMMARY

The following presents a simplified summary in order to provide a basic understanding. This summary is not an extensive overview. It is not intended to identify key or critical elements of the invention or to delineate the scope of the invention. Its sole purpose is to present some concepts of the invention in a simplified form as a prelude to a more detailed description that is presented later. Additionally, section headings used herein are provided merely for convenience and should not be taken as limiting in any way.

In accordance with one aspect of the invention, a software component such as a device driver includes an upgrade code. The upgrade code serves as an indicator of functions supported by the device driver and also serves as an indicator of ability of the device driver to replace a previously installed device driver. The use of an upgrade code also permits creation and enforcement of software component replacement policies.

In accordance with another aspect of the invention, a software component such as a device driver includes one or more compatible upgrade codecompatible upgrade codes. A compatible upgrade codecompatible upgrade code serves as an indicator of an ability of a software component to replace or function along with another software component. Use of a compatible upgrade codecompatible upgrade code permits creation and enforcement of software component replacement policies at a finer level of control than simply using an upgrade code or can simply serve as an additional or alternative component for creating or enforcing such policies.

Yet another aspect of the invention involves the inclusion of an installation code in a software component such as a device driver. An installation code can serve as an indicator that an associated component should always be installed or that further permission for installation should or must be obtained. Use of an installation code can allow mandatory installation policies to be created and enforced.

Still another aspect of the invention involves the inclusion of a digital signature with a software component such as a device driver. By including such a signature and basing the signature at least in part upon an upgrade code, a compatible upgrade codecompatible upgrade code, an installation code, or a combination of one or more of the foregoing, a source of the device driver can be verified as well as the accuracy of any included codes. The use of such a signature allows for further policy creation and enforcement, such as only installing verified components from trusted sources.

A further aspect of the invention involves a system for locating, obtaining, and installing software components such as device drivers. A computing system can send descriptive information about its device drivers to a repository of device drivers. The repository can then identify device drivers that can be used to upgrade currently installed drivers on the computing system. The computing system can then download and install the updated device drivers automatically or with some user intervention if desired. Policies relating to automatically updating software components can be created and enforced.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed. The subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 is a system block diagram of a computing system that employs driver update codes.

FIG. 2 is a system block diagram of a driver module in accordance with another aspect of the invention.

FIG. 3 is a system block diagram of a driver package in accordance with an aspect of the disclosed invention.

FIG. 4 is a system block diagram of a driver package in accordance with one or more aspects of the disclosed invention.

FIG. 5 is a block diagram of a device driver in accordance with another aspect of the disclosed invention.

FIG. 6 is a system block diagram of an update system in accordance with another aspect of the disclosed invention.

FIG. 7 is a flow diagram depicting a general processing flow in accordance with yet another aspect of the invention.

FIG. 8 is a flow diagram depicting a general processing flow in accordance with still another aspect of the invention.

FIG. 9 is a flow diagram depicting a general processing flow in accordance with still another aspect of the invention.

FIG. 10 is a flow diagram depicting a general processing flow in accordance with still another aspect of the invention.

FIG. 11 is a flow diagram depicting a general processing flow in accordance with still another aspect of the invention.

FIG. 12 is a flow diagram illustrating a method that can be used in accordance with still yet another aspect of the invention.

FIG. 13 illustrates an exemplary networking environment, wherein the novel aspects of the subject invention can be employed.

FIG. 14 illustrates an exemplary operating environment, wherein the novel aspects of the subject invention can be employed.

### DETAILED DESCRIPTION

The subject invention relates to systems and methods to facilitate replacement of software components. As used in this application, the terms “component,” “system,” “module,” and the like are intended to refer to a computer-related entity, either hardware, software (for example, in execution), and/or firmware. For example, a component can be a process running on a processor, a processor, an object, an executable, a program, and/or a computer. Also, both an application running on a server and the server can be components. One or more components can reside within a process and a component can be localized on one computer and/or distributed between two or more computers.

The subject invention is described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention. Additionally, although specific examples set forth may use terminology that is consistent with client/server architectures or may even be examples of client/server implementations, skilled artisans will appreciate that the roles of client and server may be reversed, that the subject invention is not limited to client/server architectures and may be readily adapted for use in other architectures, specifically including peer-to-peer (P2P) architectures, without departing from the spirit or scope of the invention. Further, it should be noted that although specific examples presented herein include or reference specific components such as device drivers, the invention is not limited to those specific components or device drivers and can be employed in other contexts as well.

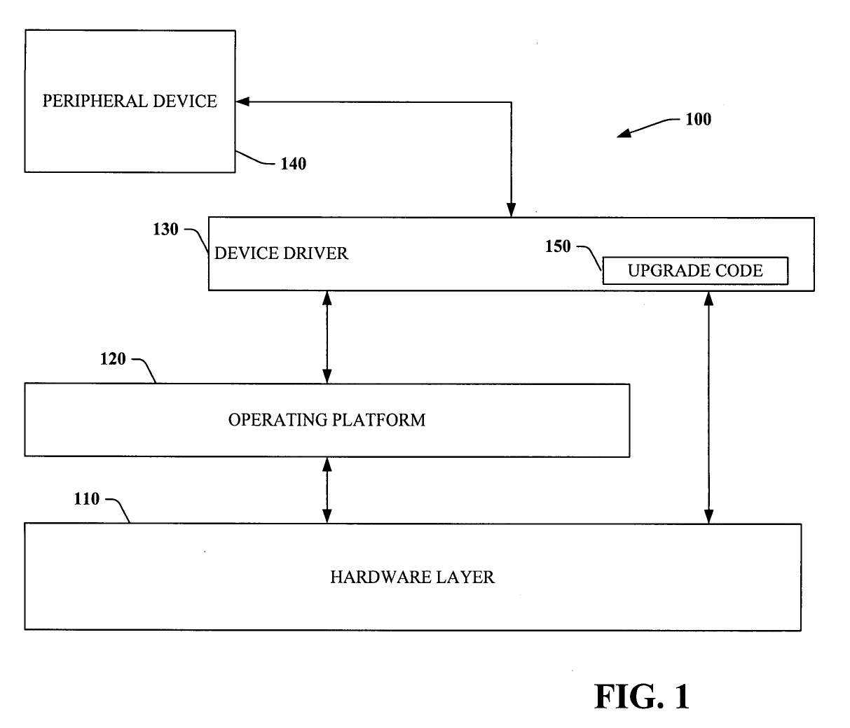

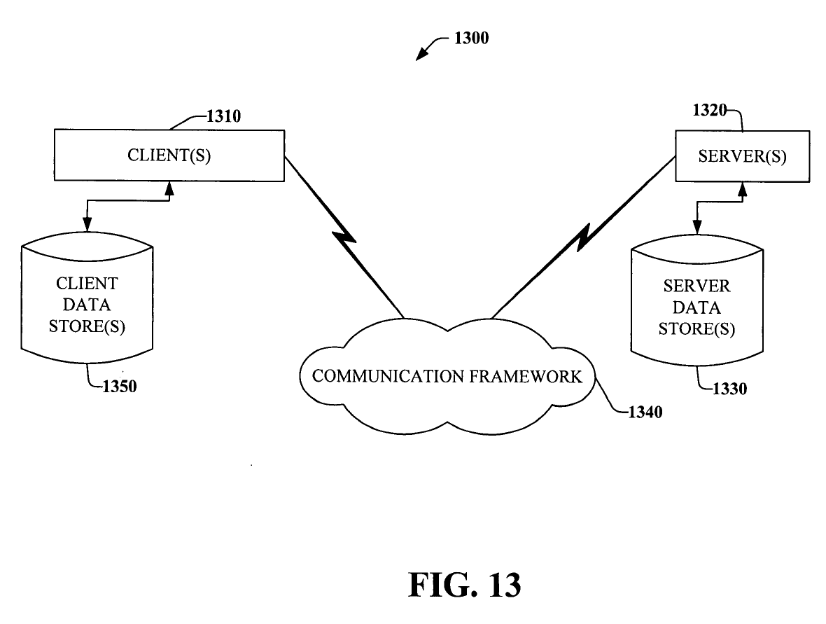

FIG. 1 is a system block diagram of a computing system 100 that employs driver update codes. The computing system 100 includes a hardware layer 110. The hardware layer 110 can include such components as a processor, non-volatile and volatile storage, communication busses, and other typical components such as those described in further detail in FIG. 13. Alternatively, other suitable hardware configurations may be used as the hardware layer 110, such as multiprocessor systems, distributed computing systems, grid computing systems, or special- or single-purpose architectures.

An operating platform layer 120 interacts with, and executes upon, the hardware layer 110. The operating platform layer 120 can be a general-purpose operating system, a specialized operating system, or another component or components that provide a sufficient operating environment for other components of the system. Specifically, the operating platform layer 120 can include a kernel to provide core operating system functions such as file and memory management as well as other modules that cooperate with the kernel to provide support for core operating system functions or services upon which higher-level components depend.

A device driver 130 can interact with the hardware layer 110, the operating platform 120, and with a peripheral device 140. The peripheral device 140 can be a video display; a printer; a network interface; an audio device such as a sound card, a speaker system, or a personal music player (for example, an MP3 player); a video device such as a digital camera or a motion picture camcorder, a personal digital assistant (PDA), or another device. The device driver 130 can provide communication services and other desired functions or services so that the operating platform 120 or the hardware layer 110 can interact with the peripheral device to access features or functions of that device. It should be appreciated that although the device driver 130 is pictured as having direct connections to both the operating platform 120 and the hardware platform 110, such connections may differ according to a specific implementation.

The device driver 130 includes an upgrade code 150. The upgrade code can take a variety of forms, such as an alphanumeric indicator, a binary code, a file name, or another suitable code. The upgrade code can be a simple numeric value or a complex encoding with fields that represent specific aspects or features of the associated device driver 130. For example, a vendor may use the value “111” for its upgrade code for a specific device driver. When the vendor releases an updated driver for that peripheral device, the updated driver will also have an upgrade code of “111,” indicating that the updated driver is intended to replace the older driver with the same upgrade code.

A second example involves encoding additional information into the upgrade code. For instance, if a vendor applies an upgrade code ABC-111-222-333 to its device driver, the upgrade code can be broken down into a group of fields with each individual field representing certain information about the device driver. The first field including “ABC” can represent that the device driver is for ABC device. ABC device can be a specific type of device, a specific model, or a specific revision of a model. Each of the next two fields, “111” and “222” can represent certain functions that are supported by the device driver. The final field “333” can be a revision date, build number, or other desired information. It should be noted that these examples are not limiting and that other types of information can be encoded into the upgrade code. Additionally, various other formats, specifically including, but not limited to, binary formats can be used.

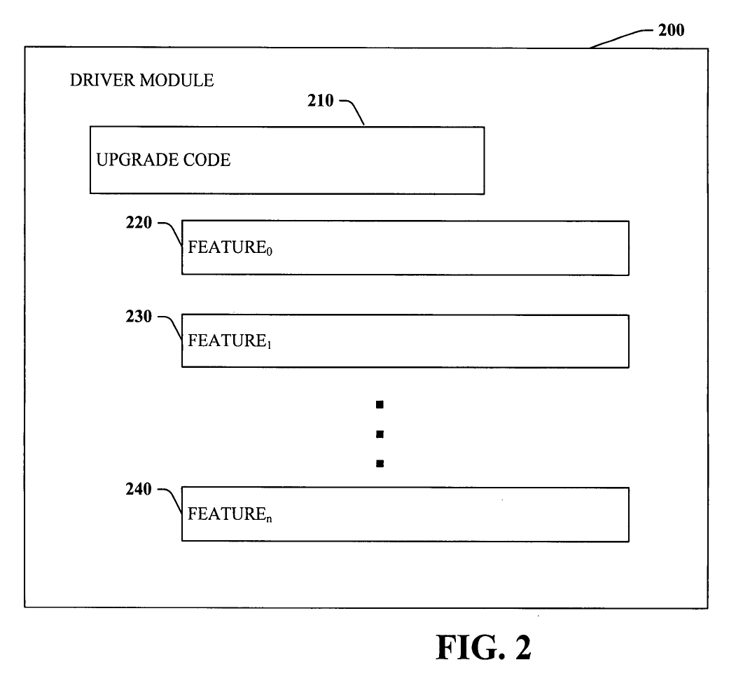

FIG. 2 is a system block diagram of a driver module 200 in accordance with another aspect of the invention. The driver module 200 includes an upgrade code 210 that can be used to check compatibility of the driver module 200 with another driver module that may replace, or be replaced by, the driver module 200. Features 220, 230, 240 are also included in the driver module 200. These features represent a set of functions that the driver module 200 is expected to perform. Although pictured as a single integrated component, those of ordinary skill in the art will recognize that the driver module 200 can be implemented in a modular fashion. Specifically, the driver module 200 can be a package including an information file or a manifest, along with other files or components described by the information file.

In use, the upgrade code 210 can be mapped to a specific feature set. In so doing, the upgrade code 210 serves as a descriptor of the functionality provided by the driver module 200. A later-released driver module having an upgrade code that is the same as an upgrade code of an older driver can be interpreted as having the same functionality as the older driver. If desired, the upgrade code in a later-released driver module can be interpreted as representing that the later-released driver provides at least the functionality of the older driver. In this case, vendors can add functionality to later-released drivers without changing upgrade codes and while still preserving backward compatibility. By adopting and adhering to such conventions, vendors and other developers can effectively create and enforce policies relating to the upgrading or replacement of driver modules or other components.

For example, a specific vendor may sell a specific computer system with a set of preinstalled device drivers that the vendor has tested with its particular system configuration. By using an upgrade code and only permitting upgrades to drivers with corresponding codes, a vendor can mitigate the risk that any system problems encountered are caused by incompatible or defective software drivers that replaced originally installed drivers. In this way, diagnosis of system problems can be greatly streamlined because the vendor can be confident that device drivers installed on the system are those that the vendor has tested and approved for use with its system configuration.

Use of upgrade codes can also enable a vendor to create device driver families. For instance, a vendor may fork a codebase of a device driver to provide differing functionality for different markets, such as a business enterprise market and a gaming market. The upgrade code for such specialized device drivers can be altered to signify that the specialized driver has been forked from a parent. Possible ways of altering the upgrade code include incrementing a value or by adding a prefix or suffix. It should also be recognized that a different upgrade code can be used for the specialized device driver and associations maintained among upgrade codes for device drivers in the same family.

The upgrade code can also be used to indicate that device drivers on different forks or from different families have been merged into a single new driver. For example, a vendor may make a variety of peripheral devices such as scanners, printers, and facsimile machines. Each peripheral device can have its own driver with an associated upgrade code. If the vendor decides to create a new peripheral device that combines the functions of all three preexisting devices, the vendor can create a new device driver for the combined device that is a combination of the preexisting device drivers. The combined driver can have its own upgrade code. The vendor can then decide to use the combined driver for all its peripheral devices even though some devices will not use all functions of the combined driver. In this case, the upgrade code for the combined driver will signify that the combined driver can replace a previous driver for one of the single-purpose devices.

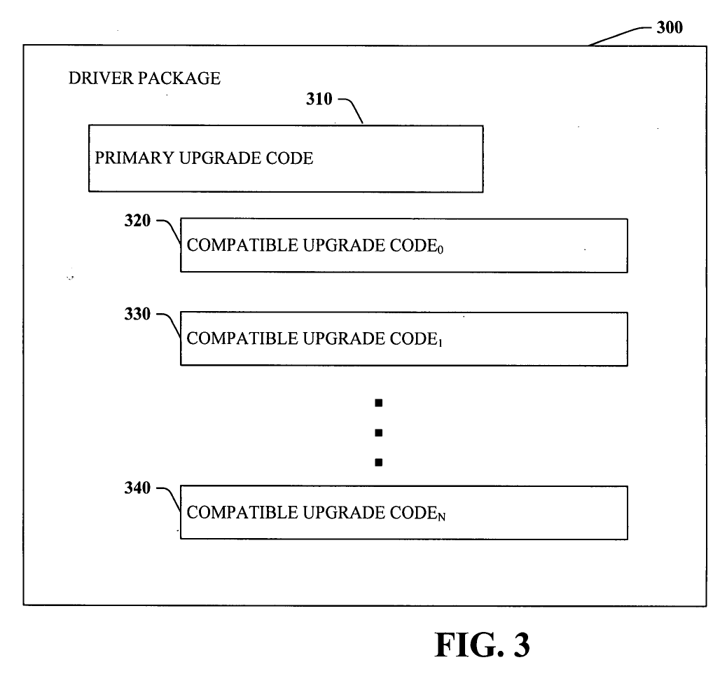

Turning now to FIG. 3, a system block diagram of a driver package 300 is presented. The driver package 300 includes a primary upgrade code 310 that can be used to verify compatibility of a replacement driver with a preexisting driver. The primary upgrade code can be implemented in any one of the ways discussed previously in reference to other upgrade codes. Compatible upgrade codeCompatible upgrade codes 320, 330, 340 are also included. The compatible upgrade codecompatible upgrade codes 320, 330, 340 can also be implemented as described with reference to other upgrade codes. The compatible upgrade codecompatible upgrade codes 320, 330, 340 describe other device drivers that the driver package 300 can replace.

Compatible upgrade codes 320, 330, 340 provide a means to obtain and exert a finer level of control over component replacement. For example, the primary upgrade code 310 can be referenced to determine whether a replacement device driver is compatible with a previously released version of that device driver. Possible interpretations of this compatibility check are a baseline guarantee of continued functionality by the replacement driver and/or a representation that coding errors present in a prior version have been repaired in the replacement driver. The compatible upgrade codes 320, 330, 340 can then signify specific drivers for which the replacement driver can be used instead. Drivers represented by the compatible upgrade codes 320, 330, 340 can be device drivers that previously have been forked into specialized families, device drivers that are previously released versions, or even device drivers from other vendors or third parties, among others.

The compatible upgrade codes 320, 330, 340 can be used in a variety of comparisons to administer or enforce a variety of policies. One possible implementation involves comparing a compatible upgrade code, such as one of the compatible upgrade codes 320, 330, 340, of a currently-installed driver with a primary upgrade code, such as the primary upgrade code 310, of a new driver to determine whether the new driver can be used to upgrade or replace the currently-installed driver. This implementation can help ensure that only compatible drivers are used to upgrade preexisting components.

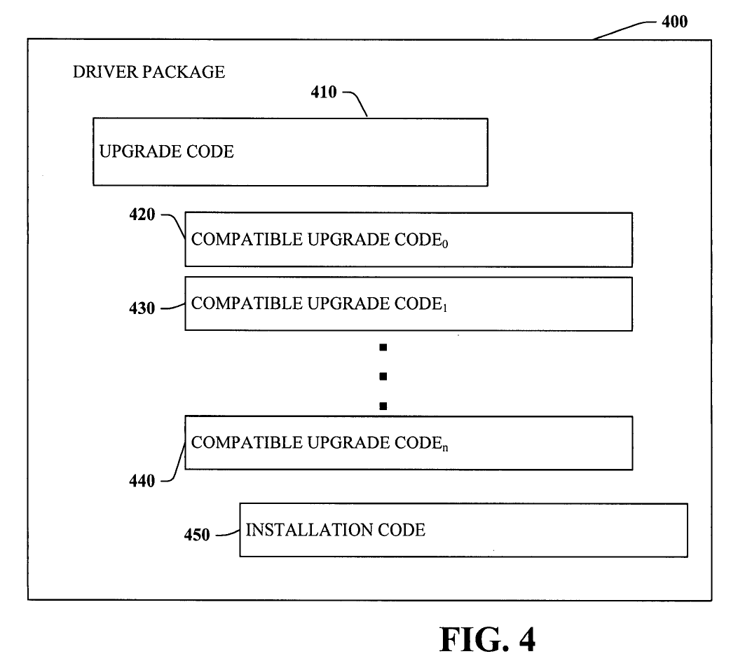

FIG. 4 is a system block diagram of a driver package 400. The driver package 400 includes an upgrade code 410 and compatible upgrade codes 420, 430, 440. The upgrade code 410 and compatible upgrade codes 420, 430, 440 can be implemented as previously described. The driver package 400 also includes an installation code 450. The installation code 450 can be implemented in a similar manner as the upgrade and compatible upgrade codes previously described or can be as simple as a single-bit flag. The installation code 450 indicates to other upgrade components (not shown), such as an operating system, whether a particular mode of replacement is indicated. For instance, when the installation code 450 is set to one value, an aggressive installation policy can be applied meaning that a replacement driver including that replacement code value will be automatically installed in place of one or more preexisting driver(s).

When the installation code is set to another value, a conservative policy, such as either prompting for permission to install or simply not installing can be followed. Here, as with other prompts, a user can be warned of possible incompatibilities or feature losses associated with the proposed installation as well as being given an opportunity to abort or continue the installation. Additionally or alternatively, the installation code 450 can be associated with an upgrade code and/or one or more compatible upgrade codes in a data store external to the driver package 400 itself. Such a data store can be local or on a remote system. In that manner, the value of the installation code 450 can be obtained without having to trust that the installation code 450 of the driver package 400 is correct.

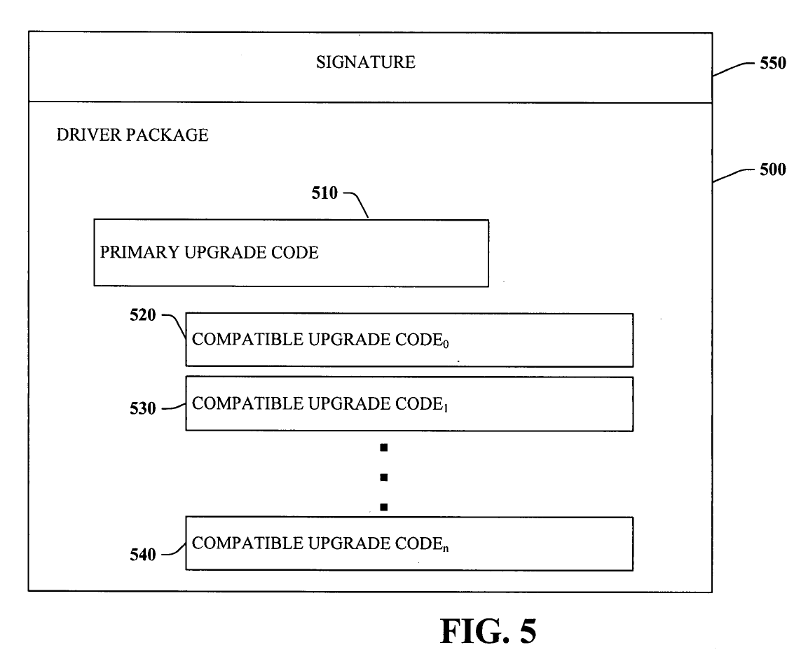

FIG. 5 is a block diagram of a device driver 500 that includes a primary upgrade code 510 and a group of compatible upgrade codes 520, 530, 540. The device driver 500 also includes a signature 550 that serves to verify integrity of the device driver 500. The signature 550 can be created using a variety of encryption methods such as private or public key encryption or various hash functions, among others. Basing the signature 550 at least in part upon the primary upgrade code 510 and/or the compatible upgrade codes 520, 530, 540 can assist in verifying not only the integrity of the device driver 500 but also of the primary upgrade code 510 and/or the compatible upgrade codes 520, 530, 540 themselves. The signature can also assist in enforcing upgrade policies by serving as an access key to the device driver to be installed. If the signature is not properly authenticated, either by decryption or some other method, the device driver will not be installed.

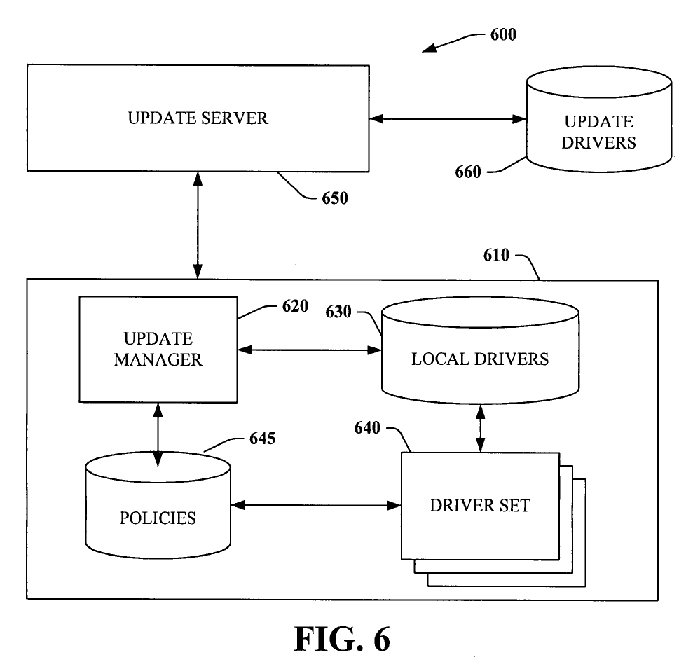

FIG. 6 is a system block diagram of an update system 600. A computing system 610 includes an update manager 620, a local driver data store 630, a set of device drivers 640, and a policy data store 645. The update manager 620 manages device driver update tasks for the computing system 610. The local driver data store 630 includes information about currently-installed device drivers such as current upgrade codes, versions, build numbers, or other suitable information. The driver set 640 is the group of device drivers currently installed on the computing system 610.

The computing system 610 is connected to an update server 650. The update server 650 accesses an update driver data store 660 that contains a set of drivers that are available to be installed. In operation, the update manager 620 can use information about the driver set 640 from the local driver data store 630 to create an update request that can be sent to the update server 650. The update server 650 can access the update driver data store 660 to determine whether a replacement driver is available for a currently installed driver on the computing system 610. The update server 650 can send a located replacement driver to the computing system 610. The update manager can use an upgrade code, a compatible upgrade code, an installation code, or a signature, alone or in combination with other components associated with the replacement driver to select an appropriate policy from the policy data store 645 and apply that policy.

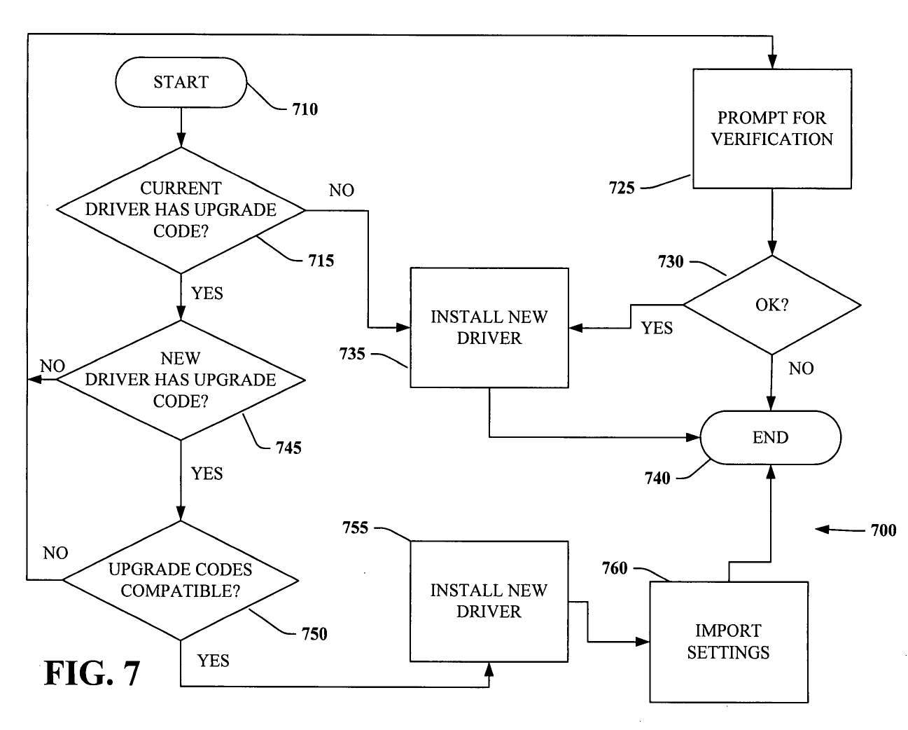

With reference to FIGS. 7-11, flowcharts in accordance to various aspects of the invention are presented. While, for purposes of simplicity of explanation, the one or more methodologies shown herein, for example, in the form of a flow chart, are shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

FIG. 7 is a flow diagram depicting a method 700 that may be employed in accordance with an aspect of the disclosed invention. Execution of the method 700 begins at START block 710 and continues to decision block 715. At decision block 715 a determination is made whether a currently installed device driver has an upgrade code. It should be noted that lack of a currently installed driver, as in the case when a new peripheral device is installed for the first time, can be treated as an instance of simply lacking an upgrade code. If the determination is no, processing continues at process block 735 where a new driver is installed. It should be noted that the new driver can have an upgrade code or can lack such a code. Processing terminates at END block 740.

If the determination made at decision block 715 is affirmative, processing continues to decision block 745. At decision block 745 a determination is made whether the new or replacement driver has an upgrade code. If no, processing continues to process block 725 where a prompt for verification or permission is created. Processing continues to decision block 730 where a determination is made whether installation of the new driver has been verified or otherwise authorized. If this determination is yes, processing continues to process block 735. If the determination made at decision block 730 is no, processing terminates at END block 740.

If the determination made at decision block 745 is yes, processing continues to decision block 750. At decision block 750, a check is performed to determine whether the upgrade codes of both the currently installed device driver and the new or replacement device driver are compatible. If no, processing continues to process block 725 where a prompt for verification or permission is created. If yes, execution continues at process block 755 where installation of the new or replacement device driver occurs. Processing then continues at process block 760 where user-selectable settings from the now-replaced driver are imported by the new or replacement driver. Processing then terminates at END block 740.

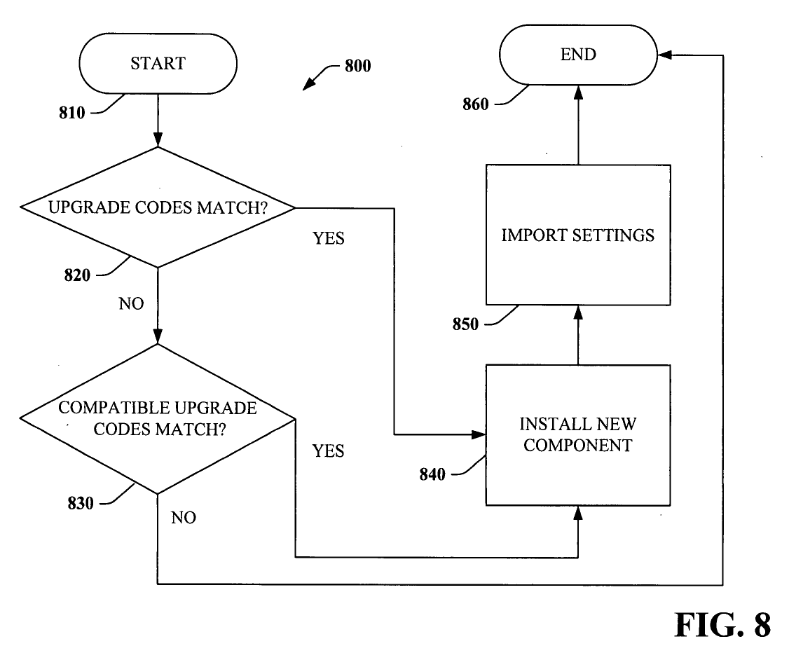

FIG. 8 is a flow diagram depicting a method 800 that may be employed in accordance with an aspect of the disclosed invention. Execution of the method 800 begins at START block 810 and continues to decision block 820. At decision block 820 a determination is made whether upgrade codes for an originally installed component and a replacement component match. If no, processing continues to decision block 830. At decision block 830 a check is performed to determine whether compatible upgrade codes for a currently installed component and a replacement component match. If yes, processing continues to process block 840. If the determination made at decision block 820 is yes, processing similarly proceeds to process block 840.

At process block 840 the replacement component is installed to replace the originally installed component. Processing continues to process block 850 where settings for the original component are imported by the replacement component. Processing then terminates at END block 860. If the determination made at either decision block 820 or decision block 830 is negative, processing also concludes at END block 860.

Those of ordinary skill in the art will appreciate that the processing flow depicted in FIG. 8 illustrates application of one or more component replacement policies. Specifically, a first policy requiring component upgrade codes to match is applied so that a replacement component is not installed unless an upgrade code of a replacement matches an upgrade code of a component to be replaced. In this context, and as applicable in other contexts, an upgrade code matches if it is exactly the same as another upgrade code or if the upgrade code has been defined as matching with another upgrade code. Determining whether codes match can be as simple as comparing the codes to each other or can involve more complex approaches such as referencing a data store of defined matches. A variety of matching schemes may be employed here as appropriate with a specific implementation of the upgrade code.

A second policy of requiring compatible upgrade codes to match is also applied here. If the compatible upgrade code of a replacement component does not indicate that the replacement component is compatible with a component to be replaced, installation will not proceed. It should be noted that in either or both of the above examples, a user may be presented with an option to override the applied policies and thereby allow installation to proceed despite a violation of the policy in place.

A third policy is that of importing settings of an original component by the replacing component. In the example illustrated in FIG. 8, when installation occurs, settings from the original component are automatically imported for use by the replacement component. In some cases this policy may not be desired. If not, a prompt may be created asking for permission to import settings. Alternatively, settings of the original component may be discarded entirely. Of course, some other appropriate policy can be created and applied as well.

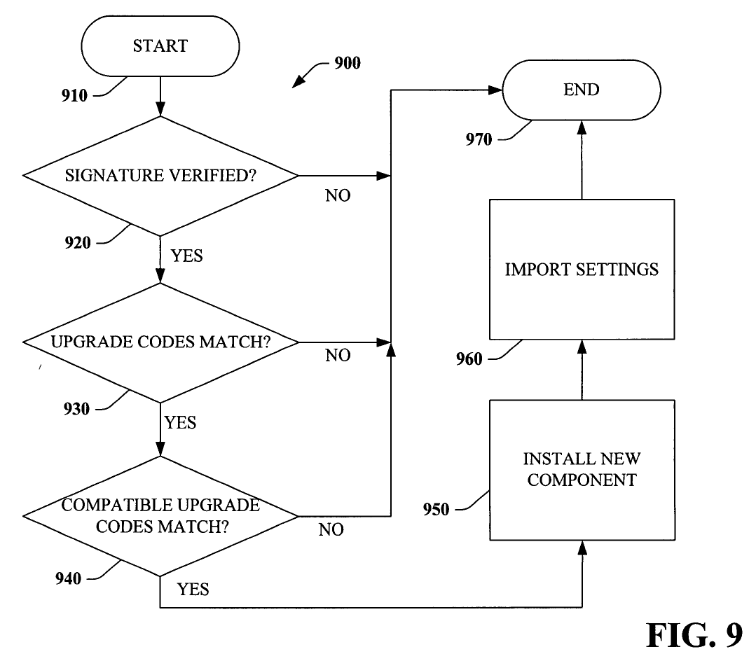

FIG. 9 is a flow diagram of a method 900 that may be employed in accordance with another aspect of the invention. Execution of the method 900 begins at START block 910 and continues to decision block 920. At decision block 920 a determination is made whether a signature associated with a replacement software component can be verified according to predetermined criteria. The signature can be verified in a variety of ways depending at least in part on how the signature initially was created. If, for example, the signature was created by applying a public key of a public/private cryptographic key pair to a filename of the software component, the signature can be decrypted by applying the private key of the cryptographic key pair to obtain the filename and verifying that the decrypted filename matches the actual filename. Also, such a technique could be used with a symmetric private key pair or some other method for generating signatures such as a hash function.

The use of a signature can help to verify that the replacement software component originated from an authentic or trusted source and that the contents of the replacement software component both are what the source purports them to be and that the replacement software component has not been tampered with or otherwise altered during transit between the source and a recipient. Use of a signature can also be triggered by an upgrade code. For example, if a non-public or a special upgrade code is used by, or assigned to a specific vendor, that upgrade code can trigger a signature check to enforce a software upgrade policy. In this instance, if an upgrade code signifies that a replacement driver can be used to upgrade a preexisting driver from a specific vendor, the signature check can be used to verify that the replacement diver originated from that vendor and is not counterfeit. A policy of only using upgrades from a specific vendor can be applied and enforced by refusing to install components that do not pass both a compatibility check and a signature check.

If the signature is verified at decision block 920, processing continues to decision block 930 where a determination is made whether an upgrade code of the replacement software component matches an upgrade code of an originally installed software component. If yes, processing continues to decision block 940.

At decision block 940, a compatible upgrade code of the replacement software component is checked with a compatible upgrade code of the originally installed software component. If the two compatible upgrade codes match or otherwise indicate compatibility between the replacement software component and the originally installed software component, processing continues at process block 950. At process block 950 the replacement software component is installed. Processing then continues at process block 960 where the replacement software component imports settings of the originally installed software component. Processing then terminates at END block 970. If the determinations made at either decision block 920, decision block 930, or decision block 940 are negative, processing also terminates at END block 970.

The termination of processing if the signature verification performed at decision block 920 fails represents an application of a policy of refusing to install a software component either from an unverified source or that includes contents that cannot be verified. As with other policies, an option may be provided to override the policy automatically or in response to an explicit command provided by an appropriate user. Additionally, the process of importing settings at process block 960 may be dispensed with or may only occur in response to an explicit instruction.

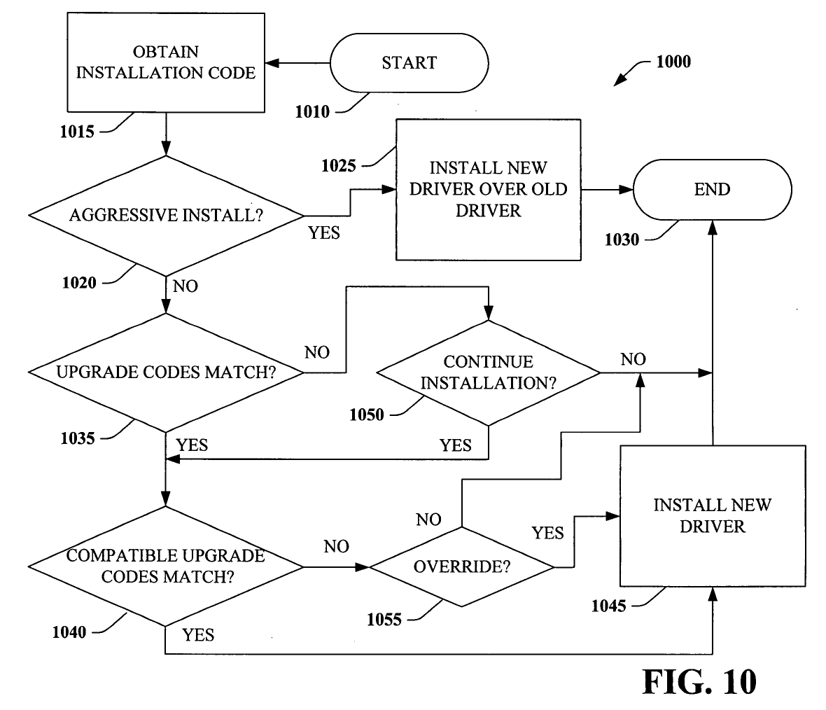

FIG. 10 is a flow diagram depicting a process 1000 in accordance with yet another aspect of the invention. The process begins at START block 1010 and continues to process block 1015 where an installation code associated with a new device driver is obtained. Processing continues at decision block 1020 where a determination is made whether an aggressive installation mode is designated by the device driver. If yes, processing continues to process block 1025 where the new device driver is installed either over a preexisting device driver or as a fresh installation if there is no preexisting driver. Processing then terminates at END block 1030.

If the determination made at decision block 1020 indicates that an aggressive installation mode is not desired, processing continues to decision block 1035 where a determination is made whether an upgrade code of the new device driver matches with an upgrade code of a preexisting device driver. If yes, processing continues to decision block 1040 where a determination is made whether a compatible upgrade code of the new device driver matches with a compatible upgrade code of a preexisting device driver. If yes, processing continues to process block 1045 where the new device driver is installed. Processing then terminates at END block 1030.

If the determination made at decision block 1035 indicates that the upgrade code of the new device driver does not match the upgrade code of the preexisting device driver, processing continues at decision block 1050 where a determination is made whether to continue installation despite the fact that upgrade codes of the device drivers do not match. If no, processing terminates at END block 1030. If yes, processing continues to decision block 1040. If the determination made at decision block 1040 indicates that the compatible upgrade codes of the device drivers do not match, a check to see if installation should continue is performed at decision block 1055. If installation should continue, processing continues to process block 1045 where the new device driver is installed. If installation should not continue, processing terminates at END block 1030.

The use of an installation code provides additional possibilities for installation policy creation and enforcement. For example, a vendor may have created an updated device driver to fix a critical flaw in its original device driver. By assigning an aggressive installation code to its updated device driver, the vendor can require that the updated device driver be installed. Similarly, a vendor can require the installation of a device driver that it has tested and approved in place of a currently installed, but untested or unapproved, device driver.

Additional policies that are illustrated by the method 1000 are to allow installation to continue despite failures of checks for matching upgrade codes and matching compatible upgrade codes. Such a policy can be appropriate, for example, for advanced users or system administrators. These and other policies can be combined or each can stand alone as a single installation policy.

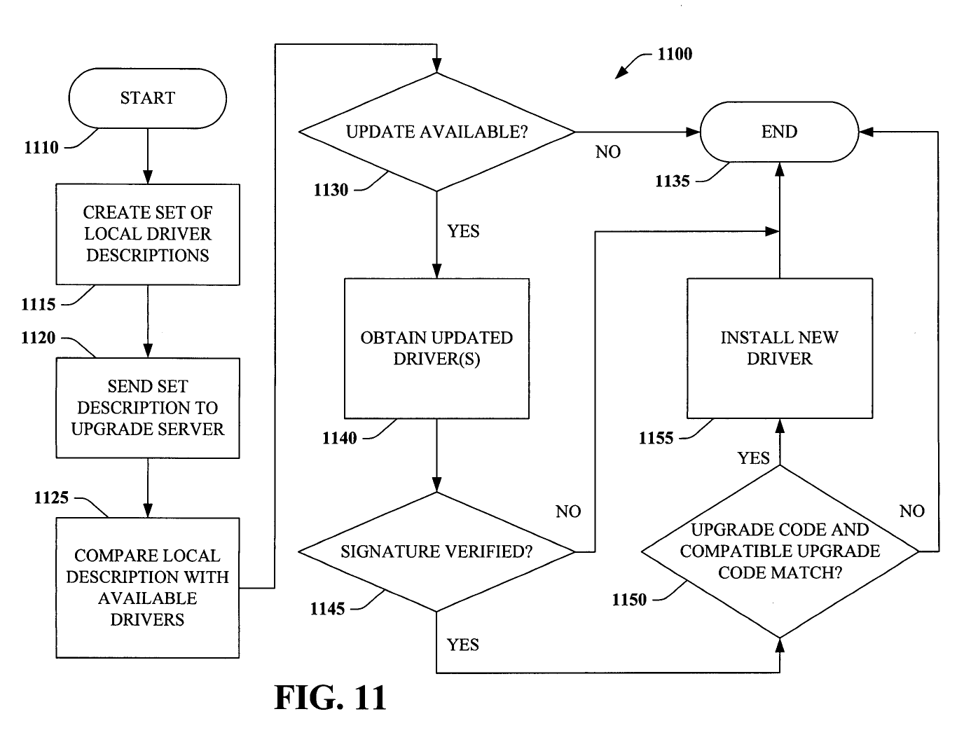

FIG. 11 is a flow diagram of a method 1100 of updating currently installed device drivers in accordance with yet another aspect of the invention. Execution begins at START block 1110 and continues to process block 1115. At process block 1115, a set of descriptions of currently installed drivers on a local computing system is created. Such descriptions can include signatures, upgrade codes, compatible upgrade codes, installation codes, version numbers, build numbers, and release dates, among others. This set of descriptions can be implemented in any suitable manner, such as a text file, a data structure, or one or more objects, among others.

At process block 1120, the set of descriptions is sent to an update server. Processing continues at process block 1125 where the set of descriptions is compared with a similar set of descriptions for device drivers that are available from the update server. At decision block 1130 a determination is made whether an updated version of a device driver currently installed on the local computing system is available on the update server. If no, processing concludes at END block 1135.

If an updated version of a device driver is available, processing continues at process block 1140 where an updated device driver is obtained by the local computing system. Processing continues at decision block 1145 where a determination is made whether a signature associated with the updated version of the device driver can be verified. If yes, processing continues to decision block 1150 where a determination is made whether an upgrade code and a compatible upgrade code associated with the updated version of the device driver match with an upgrade code and a compatible upgrade code of a currently installed device driver. If the upgrade code and the compatible upgrade codes match, installation proceeds to process block 1155 where the updated version of the device driver is installed. Processing terminates at END block 1135. If the signature cannot be verified at decision block 1145 or if the upgrade and compatible upgrade code matching fails at decision block 1150, processing will terminate at END block 1135.

The subject invention, for example in connection with selection or various pattern-matching tasks such as matching upgrade codes or compatible upgrade codes, can employ various artificial intelligence-based schemes for carrying out various aspects thereof. For example, a process for determining whether a replacement device driver is compatible with a currently installed device driver can be facilitated by using an automatic classifier system and process. Moreover, when more than one replacement driver is available, an automatic classifier system can be used to select a preferred or best replacement driver to be installed.

A classifier is a function that maps an input attribute vector, X=(x₁, x₂, x₃, x₄, . . . xₙ), to a confidence that the input belongs to a class, that is, f(X)=confidence(class). Such classification can employ a probabilistic and/or statistical-based analysis (for example, factoring into the analysis utilities and costs) to prognose or infer an action that a user desires to be automatically performed. In the case of software component replacement systems, for example, attributes can be file descriptors such as filenames, signatures, hash functions, upgrade codes, compatible upgrade codes, version numbers, build numbers, release dates, or other data-specific attributes derived from the device driver files and the classes are categories or areas of interest, for example, descriptors of other device drivers that the device driver can update.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the subject invention can employ classifiers that are explicitly trained (for example, by a generic training data) as well as implicitly trained (for example, by observing user behavior, receiving extrinsic information). For example, SVM's are configured by a learning or training phase within a classifier constructor and feature selection module. Thus, the classifier(s) can be used to automatically perform a number of functions, including but not limited to determining according to a predetermined criteria which device driver should be selected to upgrade a currently installed device driver or whether device drivers are compatible.

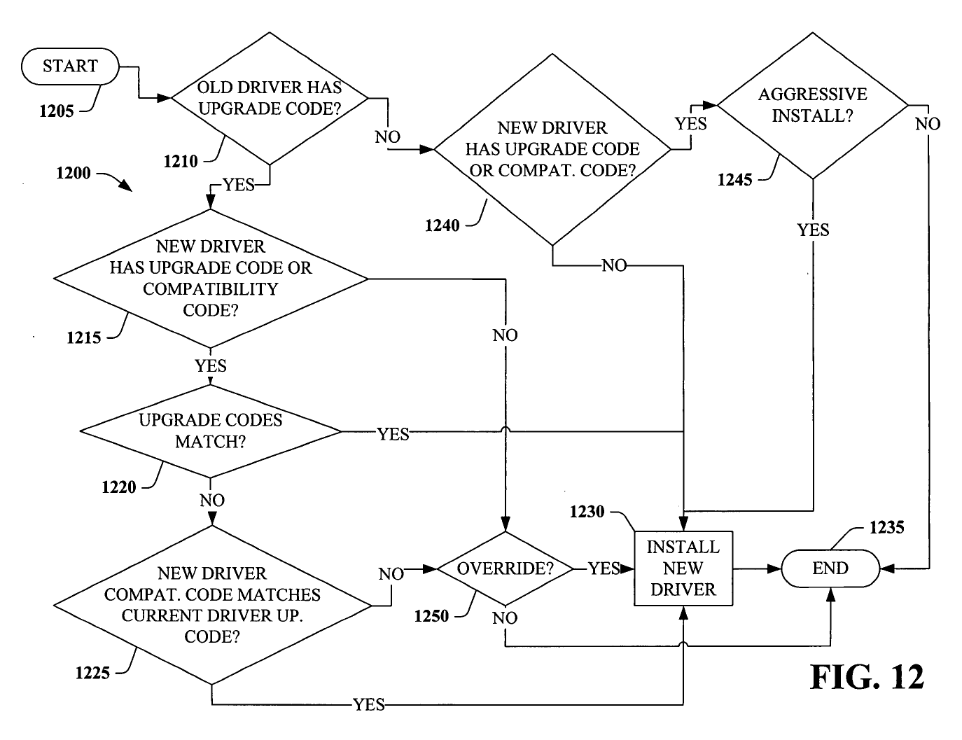

FIG. 12 is a flow diagram illustrating a method 1200 that can be used in accordance with still yet another aspect of the invention. Processing begins at START block 1205 and continues to decision block 1210. At decision block 1210 a determination is made whether an old (or currently-installed) driver has an upgrade code. If yes, processing continues to decision block 1215 where a determination is made whether a new driver has an upgrade code or a compatibility code. If that determination is yes, processing continues to decision block 1220 where a determination is made whether the upgrade codes of the drivers match. If no, processing continues to decision block 1225 where a determination is made whether a compatible upgrade code of the new driver matches the upgrade code of the currently installed driver. If yes, processing continues to process block 1230 where the new driver is installed. Processing terminates at END block 1235.

If the determination made at decision block 1210 is yes, processing continues to decision block 1240 where a determination is made whether the new driver has an upgrade code or a compatible upgrade code. If that determination is no, processing continues to process block 1230. If the determination is yes, processing continues to decision block 1245. At decision block 1245 a determination is made whether an aggressive installation mode is indicated. If yes, processing continues at process block 1230. If no, processing terminates at END block 1235.

If the determination made at decision block 1215 is no, processing continues at decision block 1250. At decision block 1250 a determination is made whether an override of installation procedures is indicated. If yes, processing continues at process block 1230. If no override is indicated, processing terminates at END block 1235. If the determination made at decision block 1220 is yes, processing continues at process block 1230. If the determination made at decision block 1225 is no, processing processing continues at decision block 1250 and thereon until processing ultimately terminates at END block 1235.

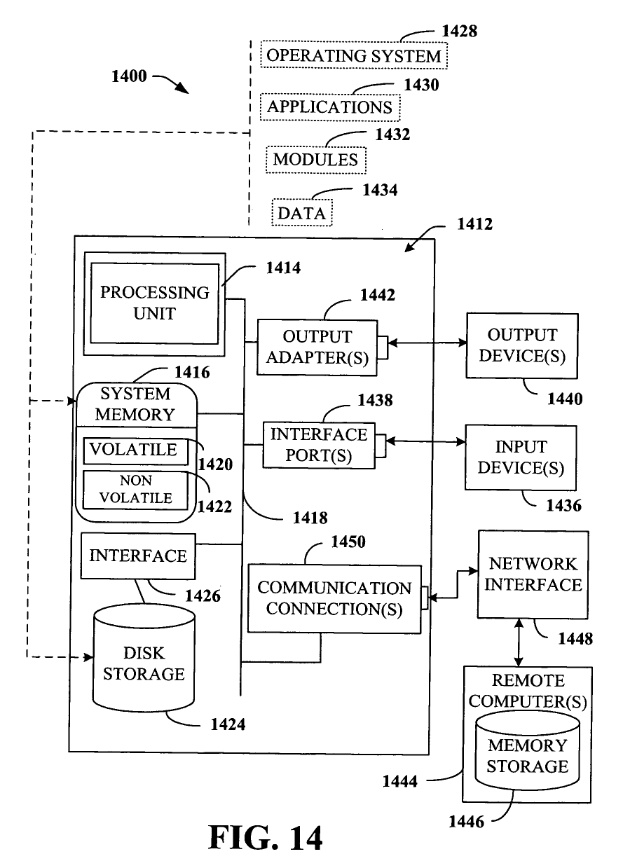

In order to provide additional context for implementing various aspects of the subject invention, FIGS. 13-14 and the following discussion is intended to provide a brief, general description of a suitable computing environment within which various aspects of the subject invention may be implemented. While the invention has been described above in the general context of computer-executable instructions of a computer program that runs on a local computer and/or remote computer, those skilled in the art will recognize that the invention also may be implemented in combination with other program modules. Generally, program modules include routines, programs, components, data structures, etc. that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the invention may also be practiced in distributed computing environments where certain tasks are performed by remote processing devices that are linked through a communications network. However, some, if not all, aspects of the invention may be practiced on stand-alone computers. In a distributed computing environment, program modules may be located in local and/or remote memory storage devices.

FIG. 13 is a schematic block diagram of a sample-computing environment 1300 with which the subject invention can interact. The system 1300 includes one or more client(s) 1310. The client(s) 1310 can be hardware and/or software (e.g., threads, processes, computing devices). The system 1300 also includes one or more server(s) 1320. The server(s) 1320 can be hardware and/or software (e.g., threads, processes, computing devices). The servers 1320 can house threads or processes to perform transformations by employing the subject invention, for example.

One possible means of communication between a client 1310 and a server 1320 can be in the form of a data packet adapted to be transmitted between two or more computer processes. The system 1300 includes a communication framework 1340 that can be employed to facilitate communications between the client(s) 1310 and the server(s) 1320. The client(s) 1310 are operably connected to one or more client data store(s) 1350 that can be employed to store information local to the client(s) 1310. Similarly, the server(s) 1320 are operably connected to one or more server data store(s) 1330 that can be employed to store information local to the servers 1340.

With reference to FIG. 14, an exemplary environment 1400 for implementing various aspects of the invention includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable ROM (EEPROM), or flash memory. Volatile memory 1420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1412 also includes removable/non-removable, volatile/non-volatile computer storage media. For example, FIG. 14 illustrates a disk storage 1424. The disk storage 1424 includes, but is not limited to, devices like a magnetic disk drive, floppy disk drive, tape drive, Jaz drive, Zip drive, LS-100 drive, flash memory card, or memory stick. In addition, disk storage 1424 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in the suitable operating environment 1400. Such software includes an operating system 1428. The operating system 1428, which can be stored on the disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the subject invention can be implemented with various operating systems or combinations of operating systems.

A user enters commands or information into the computer 1412 through input device(s) 1436. The input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

In addition, while a particular feature of the invention may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system to manage software component replacement, comprising:
a component that identifies a unique identifier associated with a software component; and
an upgrade component that applies an upgrade policy as a function of a comparison of the unique identifier with an identifier associated with software to replace.

2. The system of claim 1, wherein the component that identifies a unique identifier additionally identifies a compatibility identifier.

3. The system of claim 1, wherein the unique identifier is a name of the software component.

4. The system of claim 1, wherein the software component is a device driver.

5. The system of claim 4, wherein the upgrade policy is an assurance that the device driver provides at least a set of functions provided by the software to replace.

6. The system of claim 4, wherein the upgrade policy is a description whether the device driver is permitted to be substituted for the software to replace.

7. The system of claim 4, wherein the device driver includes a signature.

8. The system of claim 7, wherein the signature of the device driver is based at least in part upon the unique identifier.

9. A method for substituting a software component, comprising:
locating an identifying tag of a replacement software module; and
replacing a preexisting software module with the replacement software module based at least in part upon a policy associated with the identifying tag.

10. The method of claim 9, further comprising using a compatibility tag to verify compatibility of the replacement software module with the preexisting software module.

11. The method of claim 10, further comprising verifying integrity of the replacement software module.

12. The method of claim 11, wherein the act of verifying integrity of the replacement software module includes checking validity of a digital signature.

13. The method of claim 11, further comprising using configuration settings of the preexisting software module to configure the replacement software module.

14. The method of claim 11, further comprising checking an installation indicator to determine whether to replace the preexisting software module despite existence of a violation of the policy associated with the identifying tag.

15. A system for substituting a software component, comprising:
means for locating an identifying tag of a replacement software module; and
means for replacing a preexisting software module with the replacement software module based at least in part upon a policy associated with the identifying tag.

16. The system of claim 15, further comprising means for using a compatibility tag to verify compatibility of the replacement software module with the preexisting software module.

17. The system of claim 16, further comprising means for verifying integrity of the replacement software module.

18. The system of claim 17, wherein the means for verifying integrity of the replacement software module includes means for checking validity of a digital signature.

19. The system of claim 17, further comprising means for using configuration settings of the preexisting software module to configure the replacement software module.

20. The system of claim 17, further comprising means for checking an installation indicator to determine whether to replace the preexisting software module despite existence of a violation of the policy associated with the identifying tag.
